(19) United States
(12) Patent Application Publication
(10) Pub. No.: US 2016/0174643 A1
(43) Pub. Date: Jun. 23, 2016

(54) WARDROBE TAPE AND METHOD OF USING SAME

(71) Applicant: 3M INNOVATIVE PROPERTIES COMPANY, Saint Paul, MN (US)

(72) Inventors: Lisa M. MILLER, Spring Valley, WI (US); Cristin E. MORAN, Saint Paul, MN (US); Diane R. WOLK, Woodbury, MN (US); Bonnie L. NICHOL, North Saint Paul, MN (US)

(21) Appl. No.: 14/910,103

(22) PCT Filed: Aug. 7, 2014
(86) PCT No.: PCT/US14/50174

§ 371 Date: Feb. 4, 2016

Related U.S. Application Data
(60) Provisional application No. 61/863,034, filed on Aug. 7, 2013.

(51) Int. Cl. A41F 19/00; C09J 7/02

(52) U.S. Cl. CPC A41F 19/00; C09J 7/02

(57) ABSTRACT

A tape assembly comprising: (a) an elongate tape having first and second adhesive faces and (b) a liner removably adhered to the first adhesive face of the tape, the liner having a longitudinal weakened line of separation disposed in parallel to the longitudinal axis and a plurality of crosswise weakened lines of separation. Also, a method of using such tape assemblies.

### FIELD

The present invention relates to an adhesive tape, particularly, an adhesive tape for temporarily adhering a portion of a garment to a wearer's skin. It also relates to a method for using such adhesive tape.

### BACKGROUND

In many of today's fashions, particularly for women, the clothing seemingly is required to defy the laws of gravity and/or the natural curvature of the human form in order to appropriately and tastefully cover the wearer. Some women's fashions, such as, low-cut, halter, backless, and/or strapless tops and dresses, routinely gap from or slip on the wearer, which may result in exposure of an undergarment or portions of the wearer's body. Another problem area is a garment that “rides-up” and becomes uncomfortable and/or unsightly during normal wear, such as bathing suit bottoms or underpants that do not stay in place over the wearer's buttocks. The person wearing such garments may need to routinely pull-up, pull-down, and/or straighten the garment, which can be an annoyance to the wearer and unattractive to those about her.

Illustrative examples of adhesive tape devices for addressing this issue have been disclosed, including, for example, U.S. Pat. No. 6,332,825 (Henricksen), US Patent Application Publication No. 2007/0054081 (DeMarco), and GB Application No. 2,455,475 (McBride).

An illustrative commercial product is HOLLYWOOD FASHION TAPED Tape Strips.

A deficiency of current products is that they are difficult to piece into desired portion sizes, even using tools such as scissors and dispensers with sharp blades, because of the yielding backing and thick liners used.

The need exists for improved adhesive tape devices that provide easier, more convenient use.

### SUMMARY

The present invention provides a novel wardrobe tape, i.e., an adhesive tape for temporarily adhering a portion of a garment to a wearer's skin, and a novel method for using such wardrobe tape. The tape of the invention permits surprisingly easy, convenient use.

In brief summary, a tape assembly of the invention comprises at least one tape body that comprises:

(a) a tape section comprising a backing having first and second major surfaces, a first adhesive coating on at least a portion of the first major surface defining a first adhesive face, and a second adhesive coating on at least a portion of the second major surface defining a second adhesive face; and
(b) a liner removably adhered to the first adhesive face. In accordance with the invention, the tape body has: (1) at least one longitudinal line of separation formed in the liner and (2) one or more crosswise lines of separation formed in the liner and backing. The longitudinal line of separation is oriented in parallel to the longitudinal axis of the tape section. The crosswise lines of separation are oriented crosswise to the longitudinal axis of the tape section and define separable tape segments of the tape section. The longitudinal line of separation in combination with one or more adjacent crosswise lines of separation define portions of liner which can be removed to expose desired regions or portions of the first adhesive face as desired. Adjacent crosswise lines of separation define adjacent tape segments of the tape which can be separated from one another to yield dual sided adhesive tape pieces of desired size.

In many illustrative embodiments, the assembly will be in roll form with the tape wrapped around an optional core. As will be understood, in some other embodiments the assembly will be of other configuration, e.g., a stack of a plurality of strips of tape arranged on top of one another with each strip comprising two or more segments.

Briefly summarizing, an illustrative method of using such tape assemblies comprises: (a) providing a tape assembly of the invention and (b) removing a tape section from the tape assembly. Such removal may be carried out by, for instance, holding the tape assembly in hand, securing it in a dispenser, etc., and removing a tape section from a stack of tape sections in such embodiments or removing a desired portion of tape section from a roll form of assembly and separating from the remaining roll portion at a crosswise line of separation. Then the second adhesive face of such tape section (or desired portion thereof) is contacted to an adherend (e.g., typically either user's skin or garment) and adhered thereto, e.g., by pressing. Typically, (d) a first portion or optionally all of the liner on a desired portion of the tape section is removed to expose a first region of first adhesive face on such tape section; and then (e) contacting the first region of the first adhesive face on such tape section to a second adherend (e.g., typically either user's skin or a second location on the garment if the first adherend was garment, or the garment if the first adherend was the user's skin) and adhering such tape section thereto.

### BRIEF DESCRIPTION OF DRAWING

The invention is further explained with reference to the drawing wherein:

FIG. 1 is a perspective view of an illustrative roll form tape assembly of wardrobe tape of the invention;

FIG. 2 is a plan view of a portion of a tape section of an illustrative embodiment of wardrobe tape of the invention;

FIG. 3 is a cross sectional view of a segment of the wardrobe tape shown in FIG. 2; and

FIG. 4 is a cross sectional view of a portion of two segments of the tape shown in FIG. 2.

These figures are not to scale and are intended to be merely illustrative and not limiting.

### DETAILED DESCRIPTION OF ILLUSTRATIVE EMBODIMENTS

For the following defined terms, these definitions shall be applied, unless a different definition is given in the claims or elsewhere in this specification.

Unless otherwise indicated, all numbers expressing quantities of ingredients, properties such as molecular weight, reaction conditions, and so forth used in the specification and claims are to be understood as being modified in all instances by the term “about”.

As described above, a tape assembly of the invention comprises at least one tape body that comprises:

(a) a tape section comprising a backing having first and second major surfaces, a first adhesive coating on at least a portion of the first major surface defining a first adhesive face, and a second adhesive coating on at least a portion of the second major surface defining a second adhesive face; and
(b) a liner removably adhered to the first adhesive face. In accordance with the invention, the tape body has: (1) at least one longitudinal line of separation formed in the liner and (2) one or more crosswise lines of separation formed in the liner and backing. The longitudinal line of separation is oriented in parallel to the longitudinal axis of the tape section. The crosswise lines of separation are oriented crosswise to the longitudinal axis of the tape section and define separable tape segments of the tape section. Typically each tape section comprises two or more tape segments.

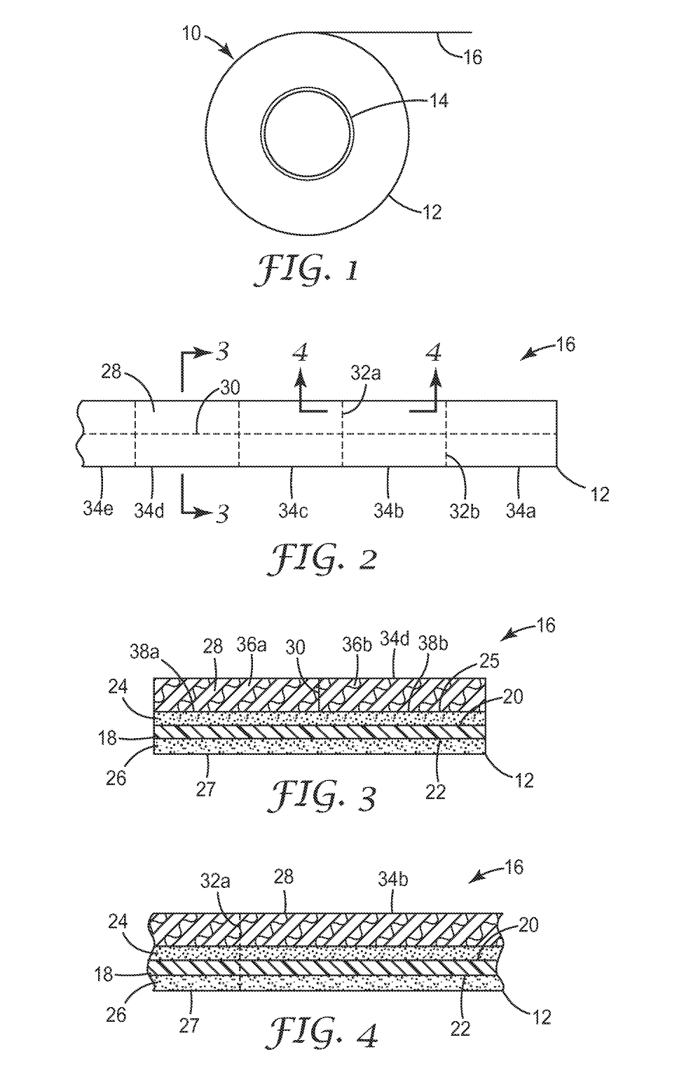

FIG. 1 shows an illustrative tape assembly 10 of the invention wherein tape body 12 is wound into roll form on optional core 14. As shown in the figure, a portion of tape section 16 of tape is removed from the roll. As will be understood by those skilled in the art, a tape section is typically elongate, often substantially rectangular in shape.

As shown in FIGS. 3 and 4, the tape of tape body 12 comprises backing 18 having first and second major surfaces 20, 22 and having first adhesive coating 24 on the first major surface defining first adhesive face 24 and second adhesive coating 26 on the second major surface defining second adhesive face 27.

The first and second adhesives each comprise pressure sensitive adhesive, and may be the same or different. The adhesive should be safe for application to skin to provide secure, temporary adhesion. In some instances, the adhesive formulation is hypoallergenic. The adhesive is preferably compatible with skin and garment materials, e.g., will not cause staining, will separate cleanly therefrom when desired, etc. The adhesive is preferably odor free, and capable of maintaining desired adhesion performance throughout expected ambient conditions of temperature, humidity, etc. Numerous alternatives of pressure sensitive adhesives for use on skin are known and those skilled in the art will be able to readily select suitable adhesive formulations for use in the invention.

In some embodiments, the adhesive coatings are substantially continuous. In other embodiments, one or both adhesive coatings may be regularly or irregularly patterned. For instance, it may be desired to use patterned coatings of adhesive to impart greater conformability, greater breathability, etc.

The backing can be any suitable sheet material and may be single ply or multiple ply. An illustrative example is polyethylene which is compatible with many skin-suitable adhesives as well as being soft, stretchable, and pliable for wearer comfort.

Liner 28 is removably adhered to the first adhesive face 25. Liner 28 serves to protect first adhesive face 25 until the tape is used and permits the tape section to be configured into a tape assembly with the first adhesive face being oriented toward the second adhesive face of an overlying portion of the second adhesive face of the tape section (e.g., when the tape is wound upon itself into roll form) or overlying second adhesive face of another tape section (e.g., when two or more tape sections are arranged in stack form).

Those skilled in the art will be able to readily select suitable liner 28. Typically it is preferred that liner 28 provide stronger bonding to the first adhesive face than to portions of the second adhesive face to which it may come into contact.

Turning to FIG. 2, liner 28 has longitudinal line of separation 30 disposed in parallel to the longitudinal axis of the tape section and a plurality of crosswise lines of separation 32a, 32b, and so forth disposed substantially crosswise to the longitudinal weakened line of separation 30. The crosswise lines of separation will typically extend substantially completely across from one edge to the opposite edge of the tape section so as to intersect the longitudinal line of separation. In the embodiment show, the crosswise lines of separation are substantially perpendicular to the longitudinal line of separation but it will be understood that other intersecting orientations may be used in accordance with the invention.

The longitudinal and crosswise lines of separation provide locations at which a desired portion or component may be removed or separate from a tape section as desired by suitable manipulation. For instance, the longitudinal line of separation provides a location at which adjacent portions of liner can be removed as desired to expose desired region(s) of the first adhesive face. Each crosswise line of separation provides a location at which adjacent tape segments may be separated, e.g., to piece a tape section from a roll, or separate linked groups of tape segments from one another.

Each line of separation, comprises, for example, at least one of a die cut line, a kiss cut line (which is a die cut line that does not extend completely through a layer or sheet), a laser die cut line, a score cut line, a perforation line, a microperforation line, a chemically etched line, a liquid etched line and/or a gas etched line.

In many embodiments it is preferred that longitudinal line of separation 30 be in the liner 28 only and not substantially impact the corresponding portion of the tape section. In many embodiments, longitudinal weakened line of separation 30 is a kiss cut that extends completely through liner 28 without penetrating into the corresponding location of the backing of that tape section, perhaps only partially, if at all, into the first adhesive coating. In some embodiments, the longitudinal line of separation will penetrate only partially though the liner 28. Referring to FIG. 3, it is shown that the longitudinal line of separation 30 and the crosswise lines of separation that bound the ends of tape segment 34d defines liner 28 into portions 36a and 36b that cover first adhesive regions 38a and 38b respectively.

Typically it is preferred that the crosswise lines of separation 32a, 32b, and so forth extend through liner 28 and the corresponding location of the backing 18 to facilitate separating segments of tape body 12, with liner 28 in position on first adhesive face 25 as desired. In many embodiments, the crosswise weakened line of separation is a perforation that preferably extends through liner 28 and preferably through backing 18. The perforation is preferably (1) sufficiently strong to permit removal of a multi-segment portion 16 of tape body 12 from roll form as shown in FIG. 1, or to remove a portion of wardrobe tape of the invention from a stack (not shown), and yet easily separated by hand when desired.

In an illustrative embodiment, the tape is about 0.75 inch (1.9 centimeters) wide (i.e., from one edge to the other), with crosswise weakened lines of separation at about 1.5 inch (3.8 centimeter) intervals, and the crosswise weakened lines of separation being perforations having ties in a range of about 6 to 9 ties/inch (2 to 4 ties/centimeter), e.g., ties being on the order of 0.03 to 0.04 inch (0.7 to 1.0 millimeter) wide. In some embodiments individual tape segments are rectangular (i.e., of the crosswise lines of separation perpendicular to the edge of the tape section) or parallelograms (i.e., if the crosswise lines of separation are parallel to one another but not perpendicular to the edge of the tape section). It will be understood that other configurations can be used in accordance with the invention.

Tape assemblies of the invention permit surprisingly easy, convenient use. Briefly summarizing, an illustrative method of using such tape assemblies comprises:

(a) providing a tape assembly of the invention;
(b) removing a tape section from the tape assembly (e.g., by removing a tape section from a stack of tape sections in such embodiments or removing a desired portion of tape section from a roll form of assembly and separating from the remaining roll portion at a crosswise line of separation);
(c) contacting the second adhesive face of such tape section to an adherend (e.g., typically either user's skin or garment) and adhering such tape section thereto (e.g., by pressing firmly);
(d) removing a first portion of liner to expose a first region of first adhesive face on such tape section; and
(e) contacting the first region of the first adhesive face on such tape section to a second adherend (e.g., typically either user's skin or a second location on the garment if the first adherend was garment, or the garment if the first adherend was the user's skin) and adhering such tape section thereto (e.g., by pressing firmly).

An advantage of the present invention is that the length of tape section applied to the first adherend can be readily configured into a desired number of segments to yield the desired size of tape. The ease by which adjacent tape segments may be separated at the crosswise lines of separation permits a user to readily obtain tape sections comprising one, two, or more tape segments as desired.

The release liner may be removed from the entirety of a tape segment at one time or in stages to review a first region of first adhesive face and then a second region of the first adhesive face as desired.

Referring to FIG. 2, section 16 of tape body 12 may comprise one or more segments, 34a, 34b, 34c, 34d, 34e as shown. This portion may be used whole or the segments divided as desired. An advantage of the present invention is that removal of the liner when desired is facilitated by the longitudinal line of separation, e.g., bending the portion to present edges of the liner for grasping and removal, and provision of a portion of tape of desired size is facilitated by the crosswise weakened lines of separation which permit the portion to consist of multiple segments which can then be readily separated by hand if desired.

The complete disclosure of all patents, patent documents, and publications cited herein are incorporated by reference.

1. A tape assembly comprising at least one tape body comprising:
(a) a tape section comprising a backing having first and second major surfaces, a first adhesive coating on at least a portion of the first major surface defining a first adhesive face, and a second adhesive coating on at least a portion of the second major surface defining a second adhesive face; and
(b) a liner removably adhered to the first adhesive face;
wherein the tape body has: (1) at least one longitudinal line of separation formed in the liner, the longitudinal line of separation being disposed in parallel to the longitudinal axis of the tape section, and (2) one or more crosswise lines of separation formed in the liner and backing, the crosswise lines of separation being crosswise to the longitudinal axis of the tape assembly and defining separable tape segments.

2. The assembly of claim 1 wherein the tape section is elongate.

3. The assembly of claim 1 wherein the tape section comprises two or more tape segments.

4. The assembly of claim 1 wherein the tape body is wound upon itself into roll form.

5. The assembly of claim 1 wherein the crosswise lines of separation are formed in both the liner and the backing.

6. The assembly of claim 1 wherein the first adhesive layer and the second adhesive layer exhibit comparable adhesive properties.

7. The assembly of claim 1 wherein the longitudinal line of separation extends completely through the liner.

8. The assembly of claim 1 comprising a plurality of tape bodies arranged in stack form, each portion comprising two or more segments of tape.

9. A method of dispensing a selected portion of tape comprising:
(a) providing a tape assembly of claim 1;
(b) removing a tape section from the tape assembly;
(c) contacting the second adhesive face of such tape section to an adherend and adhering such tape section thereto;
(d) removing a first portion of liner to expose a first region of first adhesive face on such tape section; and
(e) contacting the first region of the first adhesive face on such tape section to a second adherend and adhering such tape section thereto.

10. The method of claim 9 wherein the tape section comprises two or more tape segments.

11. The method of claim 9 further comprising separately removing a second portion of liner on the opposite side of the longitudinal line of separation from the first portion of liner.
